(19) United States
(12) Patent Application Publication
(10) Pub. No.: US 2008/0267651 A1
(43) Pub. Date: Oct. 30, 2008

(54) ELECTROSTATIC PRINTER ROLLER COOLING DEVICE

(76) Inventors: David W. Gruszczynski, Webster, NY (US); David F. Cahill, Rochester, NY (US); Susan C. Baruch, Pittsford, NY (US)

Correspondence Address: David A. Novais;Patent Legal Staff, Eastman Kodak Company, 343 State Street, Rochester, NY, 14650-2201, US

(21) Appl. No.: 11/742,004

(22) Filed: Apr. 30, 2007

(51) Int. Cl. G03G 15/20

(52) U.S. Cl. 399/69

(57) ABSTRACT

A electrostatic printer including a fuser configured to heat an receiver to a fusing temperature and a cooling device comprising one or more cooling rollers configured to cool the cooling roller from the fusing temperature to a desired temperature wherein the cooling device is configured to provide a varying rate of heat transfer across the roller so as to create a varying cooling temperature gradient.

### FIELD OF THE INVENTION

The invention relates generally to the field of print finishing, and more particularly to a device and method for a cooling roller with varying heat transfer characteristics.

### BACKGROUND OF THE INVENTION

In an electrophotographic modular printing machine of known type for example, the 2100 printer manufactured by Eastman Kodak of Rochester, N.Y., color toner images are made sequentially in a plurality of color imaging modules arranged in tandem, and the toner images are successively electrostatically transferred to a receiver member adhered to a transport web moving through the modules. Commercial machines of this type typically employ intermediate transfer members in the respective modules for the transfer to the receiver member of individual color separation toner images. Of course, in other electrostatographic printers, each color separation toner image is directly transferred to a receiver member.

Electrostatographic printers having multicolor capability are known to also provide an additional toner depositing assembly for depositing clear toner. The provision of a clear toner overcoat to a color print is desirable for providing protection of the print from fingerprints and reducing certain visual artifacts. However, a clear toner overcoat will add cost and may reduce color gamut of the print, thus, it is desirable to provide for operator/user selection to determine whether or not a clear toner overcoat will be applied to the entire print. In U.S. Pat. No. 5,234,783, issued on Aug. 10, 1993 it is noted that in lieu of providing a uniform layer of clear toner, a layer that varies inversely according to heights of the toner stacks may be used instead as a compromise approach to establishing even toner stack heights. As is known, the respective color toners are deposited one upon the other at respective locations on the receiver member and the height of a respective color toner stack is the sum of the toner contributions of each respective color and provides the print with a more even or uniform gloss.

Many electrographic printers/copiers use rollers to feed material to a nip near a web and a fusing system. In many the fusing subsystem is composed of one to two heated rollers, which are pressed together forming the nip. When a pressure sensitive roller and a heated roller form a nip. The pressure sensitive roller and heated roller are in pressure contact with one another in what is referred to as contact fusing during fusing.

In electrostatographic controlling heat transfer after fusing is crucial since when a receiver, such as paper, passes through this nip and the temperature is too high then the toner can stick to the paper and/or the receiver can stick to one or more rollers causing multiple problems and poor prints and possible maintenance problems such as paper jams. Using the roller cooling system is very important in a situation where the receiver will pass through the fuser two or more times since it is important to maintain a low temperature of the pressure roller (using the roller cooler) the 2nd pass through the fuser (when running perfected or duplex images) will not increase the gloss or over-gloss the image. In addition during long runs of lightweight paper result in heat from the fuser roller heating the pressure roller beyond its set point. This leads to pressure roller over-temperature alarms and over-glossing on the 2nd pass through the fuser. The pressure roller cooler enables control of the pressure roller at the desired temperature and thus minimizes over-temperature alarms and over-glossing. Minimizing contact skive marks is also achieved by controlling the temperature of the pressure roller to the desired temperature.

There is a need for a printer with a cooling roller that wears well and does not have associated maintenance problems but also works well with the fuser to provide increased throughput while maintaining a high level of image quality with a wide range of paper weights while minimizing skive marks on the prints and not changing any properties that are not desired, such as changing the gloss level when it is not desired.

### SUMMARY OF THE INVENTION

In one embodiment, the present invention provides an electrostatic printer including a fuser and a cooling system a roller cooling device including one or more cooling rollers in thermal communication with the pressure roller to cool the pressure roller from the fusing temperature to a desired temperature. The cooling roller includes a housing with one or more internal spaces and a fluid supply system configured to provide fluid flow at a desired temperature through the internal space to vary the heat transfer rate from the pressure roller.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 is a schematic illustration of an electrophotographic print engine or printer apparatus, having a plurality of printing assemblies or modules that may be used in accordance with the present invention.

FIGS. 2A and 2B are schematic illustrations of a representative printing assembly or module used in the print engine apparatus of FIG. 1 showing additional details.

FIG. 3 is a schematic illustration of a roller cooling system in accordance with the present invention.

FIG. 4 is a top view of one embodiment of a roller according to the present invention.

FIG. 5 is a perspective view of one embodiment of a roller cooling system according to the present invention.

FIG. 6 is a graph illustrative example of a roller-cooling curve.

FIG. 7 is a graph illustrative example of a roller-cooling curve.

FIG. 8 is a cross-sectional side view of one embodiment of a roller cooling system according to the present invention.

FIG. 9 is a perspective view of another embodiment of a roller cooling system according to the present invention.

FIG. 10 is a cross sectional view of the view of the embodiment shown in FIG. 9.

FIGS. 11a-11c are schematics of a portion of the embodiment shown in FIG. 9.

### DETAILED DESCRIPTION OF THE INVENTION

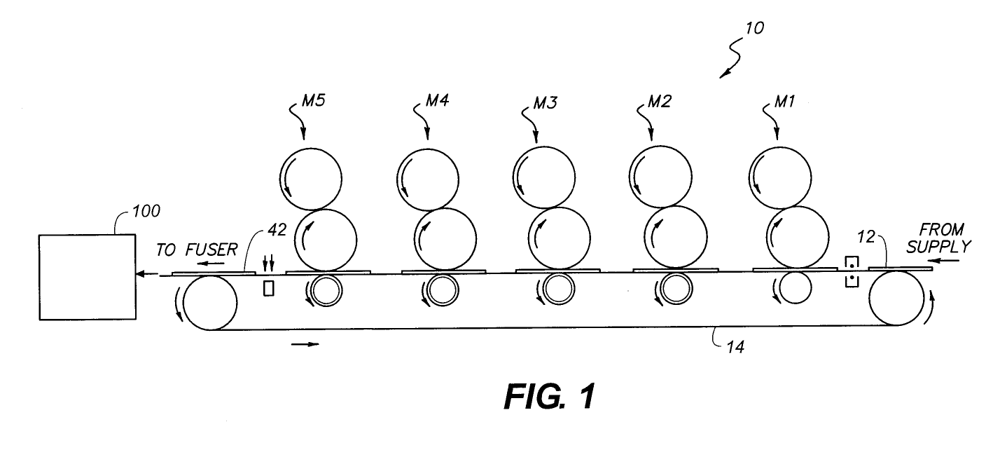

FIG. 1 is a side elevational view schematically showing portions of an electrophotographic print engine or printer apparatus 10 suitable for printing multicolor toner images on receiver members or receivers 12. A plurality of colors may be combined on a single receiver member using electrographic printers. The term “electrographic printer,” is intended to encompass electrophotographic printers and copiers that employ dry toner developed on an electrographic receiver element, as well as ionographic printers and copiers that do not rely upon an electrographic receiver. The color electrophographic printer shown in FIG. 1 employs a plurality of color toner modules (represented for reference only in FIG. 1 as M1-M5), such as the CMYK toner system, in conjunction with printing on a substrate that travels along a transport web 14. Each of the modules generates a single-color toner image for transfer to a receiver member successively moved through the modules. The modules can also be used to provide a clear toner overcoat.

The receiver 12 is advanced in the direction indicated by arrow P by a motor and/or web. Note that the substrate or receiver 12 may be any medium to be imaged and or coated such as a substrate, receiver or web. The receiver normally has a first and second opposite side such that the first side has an outside heat softenable layer upon which the toner image is formed said first pressure member contacting the image and being heated to a temperature sufficient to soften said heat softenable layer and to fix a toner image by at least partially embedding the toner image in the heat softenable layer as a result of the pressure in the nip. One skilled in the art understands that the receiver could be paper that is printed or non-printed or a non-paper, such as metal, ceramics, photoconductor, textile, glass, plastic sheet, metal sheet paper sheet and other bases that are capable of receiving a toner or toner related material. It will be understood that an optional supplementary source of heat for fusing, either external or internal, may be provided, directly or indirectly, to any roller included in a fusing station of the invention.

Each receiver 12, during a single pass by the modules, can have transferred in registration thereto, for a plurality of single-color toner images to form a multicolor image with a clear toner overcoat or other desired application. As used herein, the term multicolor implies that in an image formed on the receiver member has combinations of subsets of primary colors combined to form other colors on the receiver member, at various locations on the receiver member. The primary colors participate to form process colors in at least some of the subsets wherein each of the primary colors may be combined with one more of the other primary colors at a particular location on the receiver member to form a color different than the specific color toners combined at that location.

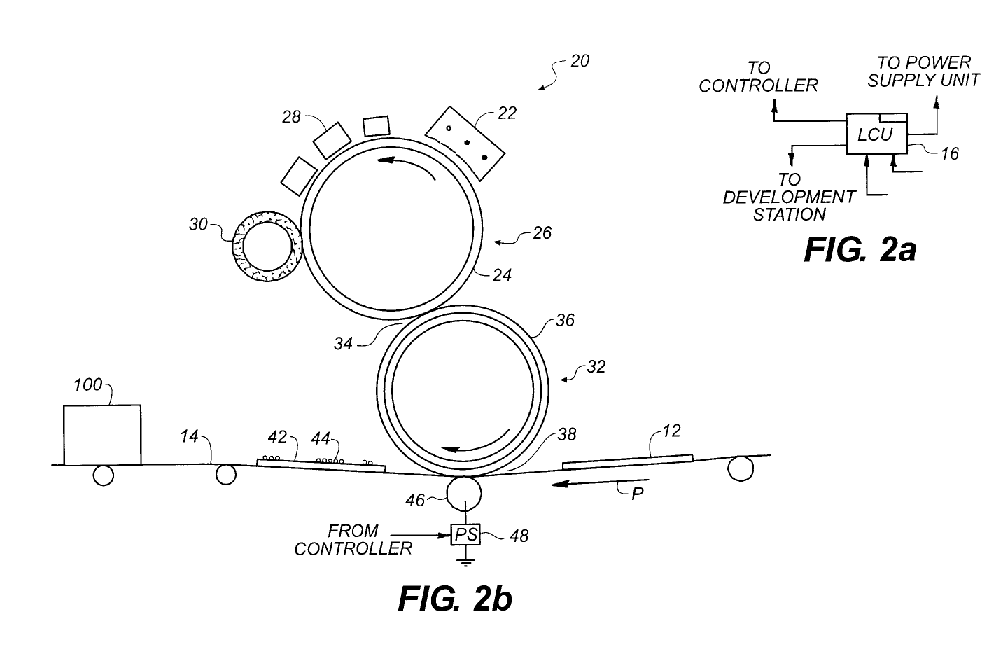

FIG. 2 shows a Logic and Control Unit (LCU) 16 which could be one or more computers, or simply a processing device or portion thereof, acting in response to signals from various sensors associated with the apparatus and provide timing and control signals to the respective components to control the various components and process control parameters of the apparatus in accordance with methods well known by those skilled in the arts. Printer 10 includes a controller or logic and control unit (LCU) 16, preferably a digital computer or microprocessor operating according to a stored program for sequentially actuating the workstations within printer 10, effecting overall control of printer 10 and its various subsystems. LCU 16 also is programmed to provide closed-loop control of printer 10 in response to signals from various sensors and encoders. Aspects of process control are described in U.S. Pat. No. 6,121,986 incorporated herein by this reference.

FIG. 2B shows a representative color-printing module. Each color-printing module 20 of the printer apparatus includes a plurality of electrophotographic imaging subsystems for producing a respective single-color toned image. Included in each module is a primary charging subsystem 22 for uniformly electrostatically charging a surface 24 of a photoconductive imaging member 26, shown in the form of an imaging cylinder. Also included is an exposure subsystem 28 for image modulation of the uniform electrostatic charge by exposing the photoconductive imaging member to form a latent electrostatic color separation image in the respective color; a development subsystem 30 for toning the exposed photoconductive imaging member with toner of the respective color; an intermediate transfer member 32 for transferring the respective color separation image from the photoconductive imaging member through a transfer nip 34 to the surface 36 of the intermediate transfer member 32, and through a second transfer nip 38 from the intermediate transfer member to a receiver member (receiver member 12 shown prior to entry into the second transfer nip 38. Also shown is receiver member 42, shown subsequent to the transfer of the toned color separation image after receiving the respective toned color separation images 44 in superposition to form a composite multicolor image thereon. An electrostatic field provided to a backup roller 46 from a power source 48 effects transfer to the receiver member. All the modules are substantially identical to the above-described module. Some of the modules transfer a type of pigmented toner and others non-pigmented toner, such as a clear toner or some other transfer material or a combination of pigmented and non-pigmented toner. The receiver then travels along the path P to a fusing system 100 including a fuser that fuses the pigmented and non-pigmented toner.

During fusing controlling heat transfer during and after fusing is critical. Using the roller cooling system is very important in a situation where the receiver will pass through the fuser two or more times since it is important to maintaining a low temperature of the pressure roller (using the roller cooler) the 2nd pass through the fuser (when running perfected or duplex images) will not increase the gloss or over-gloss the image. In addition during long runs of lightweight paper result in heat from the fuser roller heating the pressure roller beyond its set point. This leads to pressure roller over-temperature alarms and over-glossing on the 2nd pass through the fuser. The pressure roller cooler enables control of the pressure roller at the desired temperature and thus minimizes over-temperature alarms and over-glossing. Minimizing contact skive marks is also achieved by controlling the temperature of the pressure roller to the desired temperature while maintaining a high level of image quality with a wide range of paper weights while not changing any properties that are not desired such as changing the gloss level when it is not desired. This is especially important when the paper is light and/or is run through the fuser more then one time, as in duplex operations since the heat can actually melt and gloss already applied to the other side. This is called “over glossing” and is undesirable. The cooling roller system will allow a temperature sensitive material to be used on the pressure roller. A material such as Teflon™ is useful because it aids in paper movement without sticking. The use of a material such as Teflon™ is only possible when there is adequate cooling as supplied by the roller cooling system.

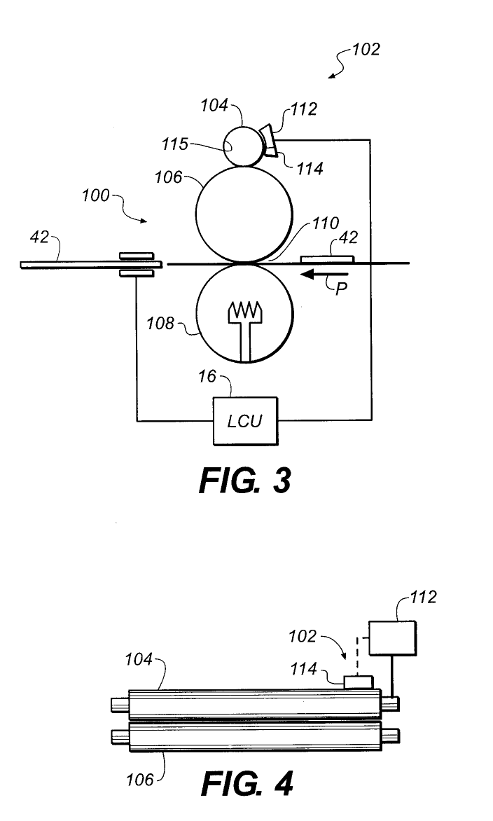

FIG. 3, shows generally schematically, the fusing system 100 of this invention including one or more rollers that is a portion of an electrographic apparatus 10. This embodiment has a roller cooling system 102 sometimes referred to as a roller cooling device with an associated method of operation. The rolling cooler system includes one or more cooling rollers 104 proximate a pressure roller 106 as well as a heating roller 108 wherein the heating roller and the pressure roller are sometimes referred to as a first and second pressure member respectively. The pressure roller 106 and the heating roller 108 forms a fusing nip 110 where the receiver passes. The heating roller has a heating system as well as one or more sensors, including densitometers to indicate the quality of toner lay down.

The cooling system 102 shown in FIG. 4 is proximate the pressure roller 104 and includes a cooling controller 1 12 that may communicate with a sensor 114 that is in communication with the LCU 16 and thus all other printing systems and subsystems. When toned paper or receiver 44 passes through the nip 10 the dry toner melts and may stick to the paper since the receiver's temperature rises rapidly during fusing. In order to minimize this problem it is important to cool the receiver down after fusing various cooling techniques have been developed and employed by electrostatic printers for cooling printed receivers plate.

The roller cooling system 102 including the cooling roller 104 can be near or can come in contact with the pressure roller 106 and can be controlled in a number of ways including a feedback algorithm that may be contained in the controller that can vary air flow, the incident angle the air contacts the pressure roller 106, distance from the receiver surface, air flow rate or capacity, number of openings and their size distribution and nozzle if needed, paper type and size as well as other factors that impact the image and printed receiver and that can be sensed or determined.

The air supply system is configured to provide a plurality of flows at the desired temperature levels through the cooling roller 104, including a hollow tube with one or more internal spaces 115 for fluid flow, so that the cooling roller 104 can to vary the heat transfer rate across the transport path so that it impacts the paper in the areas in contact with the pressure roller.

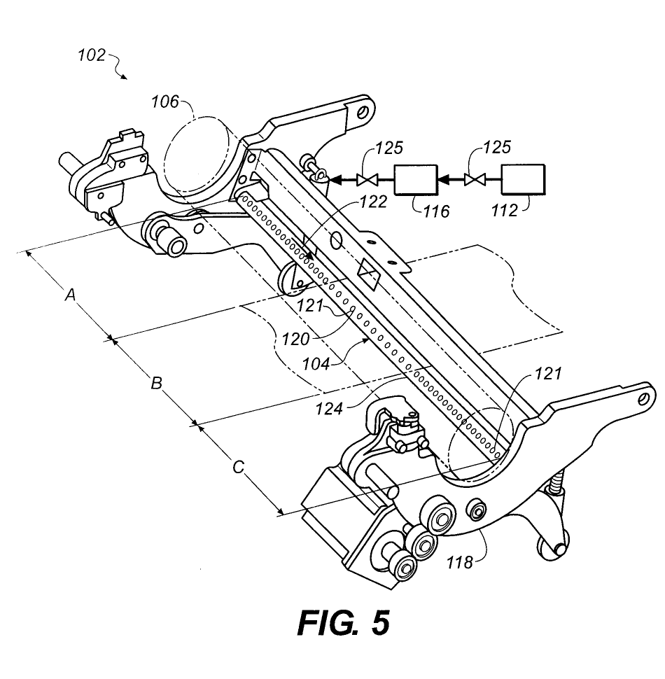

FIG. 5 shows one preferred embodiment of the roller cooling system 102 including an air supply 116 and a supporting structure 118 for the cooling roller 104 that is shown with a housing defining openings 120 that may include nozzles 121. This embodiment uses forced air through openings in the cooling tube. These opening may be evenly spaced along the cooling roller or spaced according to the position relative to the placement of the perceiver as it passes the pressure roller. In FIG. 5 this anticipated placement is shown to be between B, where A to B and B to C are areas that may not be proximate the receiver and may need additional cooling or different cycles of cooling. Since the cooling roller is hollow to move a fluid 122, in this case air, it is capable of cooling the pressure roller without harming the receiver and final printed image. The nozzles or holes in the cooling roller can be arranged in a non-uniform manner along one or more sides of the cooling roller 104 so that the holes were grouped where the paper was so that the cooling device provides a lower temperature along the edges of the transport path to vary the heat transfer rate between the area containing a receiver and the area without a receiver or vice versa. It is also possible to arrange the holes in a spiral or other pattern so that in conjunction with a rotating cooler roller the cooling effect could be varied as required.

The roller cooling system 102 embodiment shown in FIG. 5 includes an aluminum tube 124 or shell that has a number of holes 120, for example 46 holes that are approximately 0.4 mm diameter such that the holes are proximate the pressure roller 106 where the incident angle of the air on the pressure roller 106 is approximately 50 degrees from perpendicular to the roller surface. Other materials could be used as a substitute to the aluminum as long as it is an effective housing and support for the openings if needed and/or heat transfer material if needed. The tube uses approximately 110 NL/min of airflow. The flow of air is controlled with an on/off valve 125 (proportional control valve is another option). The air is turned on when the roller temperature is above the aim temperature. In one test run with lightweight paper the pressure roller without the roller cooler, during a long run of the receiver 12, a lightweight paper (80 gsm) in this case, the pressure roller heated to 115 C (setpoint 95 C) and caused the roller to activate an over-temperature sensor to actuate due to high temperatures. After the roller cooler system 102 was installed as described above, the pressure roller cooler system was able to maintain a constant temperature of 85 C throughout the same duration print run with the same paper.

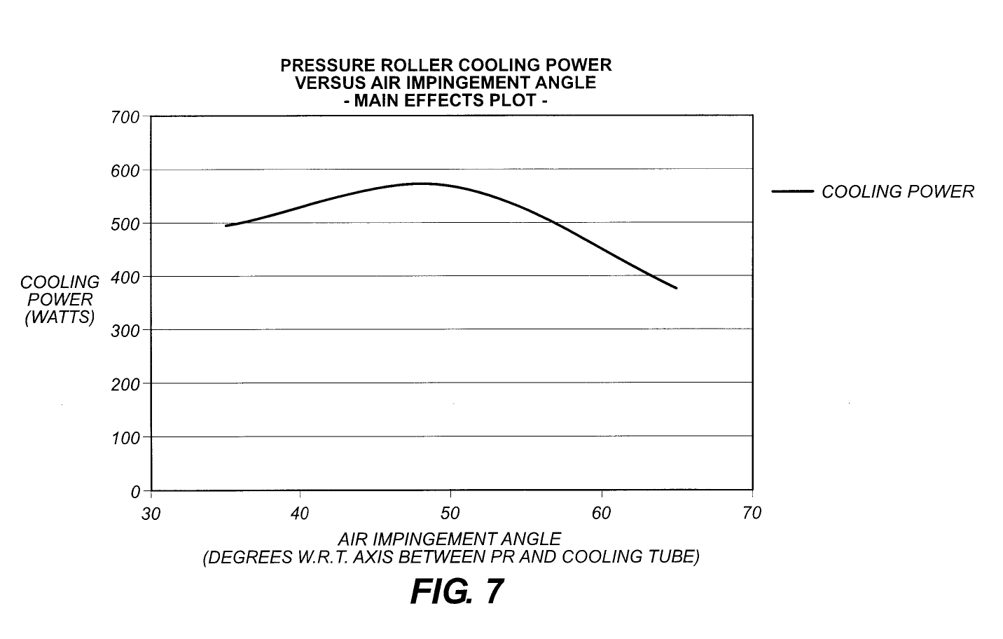

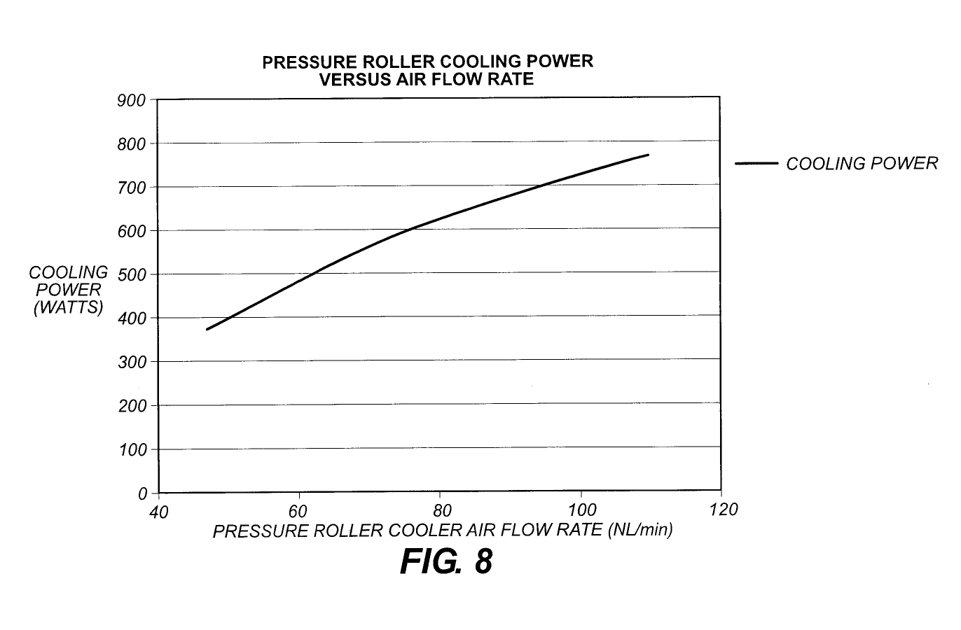

The roller cooling system 102 including the cooling roller 104, can be near or can come in contact with the pressure roller 106. The controller 112 optimizes the relevant factors including airflow and incident angle, which in this embodiment should be above approximately 35 degrees but probably above 50 degrees. The distance to the receiver was near enough to maximize incident angle and flow without casing interference with the receiver and was between 1 to 3 mm in this example. The airflow rate or capacity and number of openings and their size distribution and nozzle were maximized since more flow resulted in better cooling in this embodiment. The holes were about 4 mm diameter and spaced 8 mm apart but other sizes and spacing would be useful as discussed above, for different receiver types and sizes as well as treatments and other factors that impact the image. Some of the results are discussed below in conjunction with FIGS. 7 and 8 that provide some resulting data for the above embodiment including the impact of air impingement angle and airflow rates.

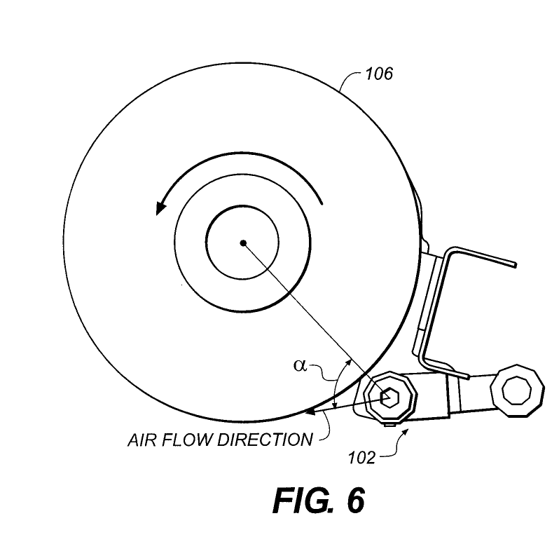

FIG. 6 shows a partial cross section of the cooler roller system 102 of this embodiment proximate the pressure roller 106 as the pressure roller rotates. The air flow from the cooling roller 104 exits in the direction of arrow A and impacts the pressure roller 106 at an air impingement angle α which is the angle between the air flow A and a line between the cooling roller 104 and the axis of the pressure roller 106, as shown. This air impingement angle α is an indication of the angler that the forced air will hit the pressure roller and is directly related to effectiveness of the cooling roller.

FIG. 7 shows a plot of Pressure Roller Cooling Power Versus Air Impingement Angle. This plot shows the main effects that impact cooling including the cooling power in Watts that results in an optimum air impingement angle α (degrees w.r.t. axis between PR and cooling tube) shown here as the peaks. The results show that at 35, 50 and 65 angles respectively that the cooling power in watts was about 496, 582 and 378 respectively where 50 degrees gave the best cooling for this embodiment.

| Angle | Cooling |
|---|---|
| ‘Deg.’ | Power |
| 35 | 497 |
| 50 | 572 |
| 65 | 378 |

FIG. 8 shows a plot of Pressure Roller Cooling Power Versus Air Flow Rate that shows the cooling power in Watts versus Pressure Roller Cooler Air Flow Rate (NL/min). The results show that at air rates of 47, 76 and 110 respectively that the cooling power in watts was about 370, 600 and 720 respectively where the greatest airflow gave the best cooling as summarized below.

| Flow | Cooling |
|---|---|
| ‘NL/min’ | Power |
| 47 | 370 |
| 76 | 600 |
| 110 | 720 |

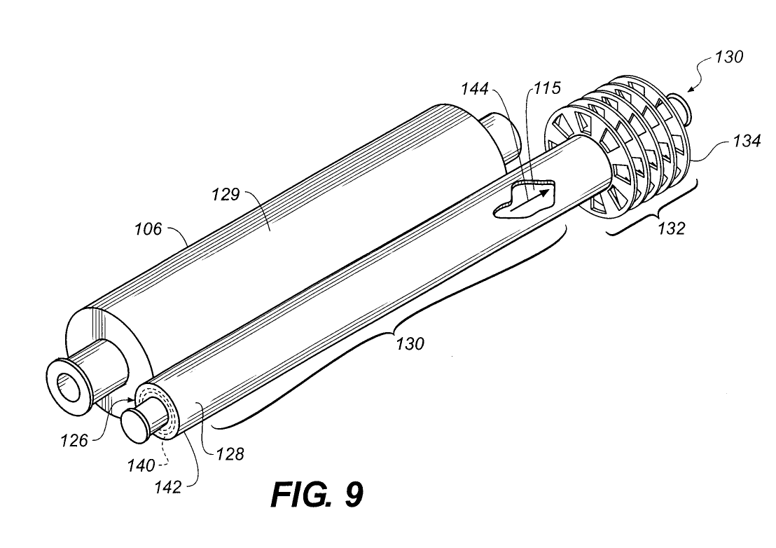

In another embodiment of the roller cooling system 102 the cooler roller 104 contacts the surface of the pressure roller 106 shown in FIG. 9. In this embodiment, the cooling roller 126, sometimes referred to as a heat transfer tube or rotating heat pipe, can rotate. Normally the surface 128 has no holes in this embodiment so that the fluid 122 flowing inside is contained when the cooling roller 126 comes in contact with the pressure roller surface 129. The rotating cooling roller 126 can transfer heat from the pressure roller surface 129 as it rotates. The working fluid 122 in this embodiment includes a phase change component so that the fluid in the evaporator section 130 of the cooling roller 126 changes phase from the liquid to gaseous phase causing a pressure gradient between the evaporator 130 and condenser 132 sections. This pressure gradient causes the produced gas to flow to the colder condenser section 132 where the gas condenses back to a fluid 122. The heat removed from the gas is transferred to cooler air in the back of the fuser subsystem by rotating one or more finned cooling plates 134. The fluid 122, which was condensed in the condenser section 132 of the cooling roller 126, is drawn back to the evaporator section 130 with a wick 140 in the cooling roller 126. There are various types of wick designs, which could be used for this application. The wick 140 is preferably designed specifically for the heat load the cooling roller 126 would need to remove.

The advantage of using the cooling roller 126 in the cooling system is that there is a sealed tube or shell 142 that does not release any fluid or gas and results in axial temperature uniformity. Also when a known liquid to gas phase change temperature controls the shell surface temperature for the working fluid the results can be optimized for certain circumstances and receiver types (weight, finish composition etc) as discussed above. This temperature can be adjusted for the design application by selecting the type of fluid used and the pressure the pipe charged at. In addition there is only a need for minimal airflow around the pressure roller surface. The cooling system's cooling airflow is self generated and is concentrated in the back of the machine where it's hot surfaces could not be touched by the customer.

The embodiment of the roller cooling system 102 shown in FIG. 9 includes the evaporator section 130 and the condenser section 132 and is shown with the optional heat dissipation or cooling fins 134. The cooling roller 126 is hollow to include a phase change fluid 144 that may pass through the tube and evaporator section 138. The typical materials to use for the heat pipe in this embodiment are listed in the table below:

| Pipe Core | |
|---|---|
| material/Surface coating | Working fluids |
| Copper/Silverstone | Water, Ammonia |
| or Nickel | |
| Stainless | Water, Ammonia |
| Steel/Silverstone or Nickel | |

The coating on the surface of the cooling roller 126, sometimes referred to as the heat pipe, needs to be wear resistance and easily cleanable. In one embodiment the typical heat pipe diameter for this application would be 50 mm.

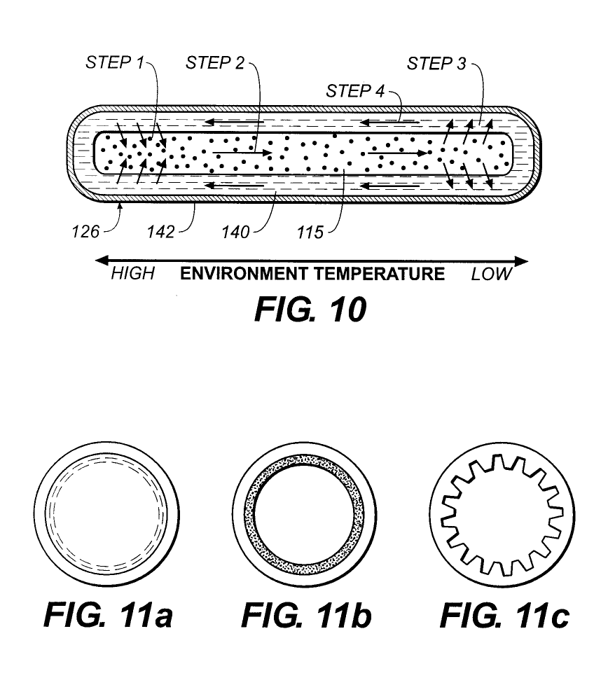

FIG. 10 shows a cross section of the rotating cooling pipe 126. The heat pipe or cooling roller 126 contacts the pressure roller 106 as needed to keep the pressure roller surface below a set temperature. When the heat pipe comes in contact with the pressure roller surface, it rotates pulling heat from the pressure roller surface. The transferred to the heat pipe causes the working fluid in the heat pipe in the evaporator section to change phase from the liquid to gaseous phase. This causes a pressure gradient between the evaporator and condenser sections. This pressure gradient causes the gas to flow to colder condenser section where the gas condenses back to a fluid. The heat removed from the gas is transferred to cooler air in the back of the fuser subsystem by the rotating finned cooling plates. The fluid, which was condensed in the condenser section of the heat pipe, is drawn back to the evaporator section with a wick in the heat pipe.

FIG. 10 shows how the heat pipe of this embodiment works. The heat pipe thermal cycle includes basically 4 steps indicated by steps 1, 2, 3 and 4 on FIG. 10. Step 1 is when the working fluid evaporates to a vapor thus absorbing energy. In step 2 the vapor migrates along a cavity to a lower temperature end. In step 3 the vapor condenses back to a fluid and is absorbed by the wick (see a variety of embodiments for various wicks that could be used but this invention is not limited to the use of only those wicks. Other wicks could be used or a combination of designs as needed. Finally in step 4 the working fluid flows hack to a higher temperature end.

FIG. 11 shows various types of wicks, which could be used for this application and could be designed specifically for the heat load the heat pipe would need to remove. These include a wrapped screen, a sintered metal and an axial groove. Each type of wicking design is discussed in more detail below in relation to FIGS. 12a-12c. FIG. 11a is a wrapped screen mesh wick. This type of wick is used in the majority of the products and provides readily variable characteristics in terms of power transport and orientation sensitivity, according to the number of layers and mesh counts used.

FIG. 11b is a sintered metal wick. The use of this type of wick will provide high power handling, low temperature gradients and high capillary forces.

FIG. 11c is a grooved tube wick. This type of wick takes advantage of the small capillary driving force generated by the axial grooves is adequate for low power heat pipes when operated horizontally.

Materials the heat pipe could be made with include:

| Pipe Core | |
|---|---|
| material/Surface coating | Working fluids |
| Copper/Silverstone | Water, Ammonia |
| or Nickel | |
| Stainless | Water, Ammonia |
| Steel/Silverstone or Nickel | |

As described above, the coating or surface on the cooling rollers needs to be wear resistance and easy to clean. In one embodiment the optimum heat pipe diameter would be 50mm. This embodiment results in a number of advantages over existing systems including uniform axial temperature since the heat pipe surface temperature is controlled by the liquid to gas phase change temperature of the working fluid and this temperature can be adjusted for the design application by selecting the type of fluid used and the pressure the pipe is charged at. This embodiment also results in the need for a minimal airflow around the pressure roller surface which is often desired since it is less disruptive of the printing process and creates less environmental impacts. Since the cooling airflow in this embodiment is self-generated and is concentrated in the back of the machine there are no hot surfaces that the customer or even operator will touch making this a safer embodiment.

The invention has been described in detail with particular reference to certain preferred embodiments thereof, but it will be understood that variations and modifications can be effected within the spirit and scope of the invention.

### PARTS LIST

M1-M5 color tone modules
10 printer apparatus
12 receiver
14 transport web
16 logic control unit (LCU)
P paper path
18 meter or sensor
20 color printing module
22 primary charging subsystem
24 surface
26 photoconductive image member
28 exposure subsystem
30 development subsystem
32 transfer member
34 transfer nip
36 surface
38 second transfer nip
40 receiver member
42 receiver member
44 separation images
46 backup roller
48 power source
100 roller cooling system
104 cooling roller
106 pressure roller
108 heating roller
110 nip
112 controller
114 sensor
115 space with openings
116 air supply
118 frame
120 openings
121 optional nozzle
112 fluid, ie. air flow
124 shell
125 on/off control valve
126 another cooling roller (closed system)
128 cooling roller surface
129 pressure roller surface
130 evaporator section
132 condenser section
134 fins
136 fluid flow ie phase change fluid
138 evaporator section
139
140 wick
142 shell or tube
144 fluid flow i.e. phase change fluid

1. An electrostatic printer, comprising:
a fuser configured to heat an receiver to a fusing temperature;
a pressure roller in thermal contact with the fuser; and
a roller cooling device comprising one or more cooling rollers in thermal communication with the pressure roller to cool the pressure roller from the fusing temperature to a desired temperature wherein the cooling roller comprises:
a. housing with one or more internal spaces;
b. a fluid supply system configured to provide fluid flow at a desired temperature through the internal space to vary the heat transfer rate from the pressure roller.

2. The electrostatic printer of claim 1, wherein the internal space has evenly spaced openings to allow a volume of airflow through the openings.

3. The electrostatic printer of claim 1, further comprising a controller to control the temperature and velocity of the fluid flow.

4. The electrostatic printer of claim 1, wherein the internal space has openings wherein a volume of airflow through the openings is higher in the area of the roller that is not in contact with the receiver as often.

5. The electrostatic printer of claim 4, wherein the temperature airflow through the openings is lower in the area of the roller that is not in contact with the receiver as often.

6. The electrostatic printer of claim 1, wherein the roller cooling system comprises a closed system with the fluid further comprising a heat transfer material.

7. The electrostatic printer of claim 1, wherein the cooling device provides a varying heat transfer rate which is greater in areas that have less receiver contact in order increase the heat transfer rate between the cooling roller and these areas with less contact with a receiver.

8. The electrostatic printer of claim 1, where the cooling roller includes heat dissipation fins.

9. The electrostatic printer of claim 1, wherein the rollers each include a sleeve of a temperature sensitive material.

10. The electrostatic printer of claim 8, where the material is Teflon™.

11. An electrostatic printing method, comprising:
forming a toner image on a first side of a receiver having first side with an image and a second opposite side;
feeding said receiver into a fuser nip, said pressure roller contacting the second side of said receiver;
bringing said pressure roller in thermal communication with a cooling roller; and
cooling said pressure member to a temperature below the temperature of the fusing nip to provide a temperature gradient greater than 40.degree. C. between the fuser and the receiver.

12. The method according to claim 10 further including the step of monitoring the temperature of the pressure member and actively cooling said pressure member when its temperature reaches or exceeds a predetermined level.

13. The method according to claim 10 wherein said cooling roller comprises nozzles to force an airflow through the nozzles so that it impacts the receiver at an impingement angle.

14. The method according to claim 12 wherein said impingement angle is less then 65 degrees.

15. The method according to claim 12 wherein said impingement angle is approximately 50 degrees.

16. The method according to claim 12 wherein said impingement angle is between approximately 35 and 55 degrees.

17. The method according to claim 10 wherein said cooling roller comprises a closed fluid supply system comprising a fluid including heat transfer fluid material.

18. The method according to claim 10 wherein said cooling roller contacts the pressure roller and further comprises a internal space including openings wherein a volume of fluid flows.

19. The method according to claim 10 wherein said cooling roller contacts the pressure roller periodically.

20. An electrostatic printer, comprising:
a fuser configured to heat an receiver to a fusing temperature;
a pressure roller in thermal contact with the fuser; and
a roller cooling device comprising one or more cooling rollers in thermal communication with the pressure roller to cool the pressure roller from the fusing temperature to a desired temperature wherein the cooling roller comprises:
a. a housing with one or more internal spaces unevenly spaced along the housing to allow varying amounts of fluid flow to communicate with the roller
b. a fluid supply system configured to provide fluid flow at a desired temperature through the internal space to vary the heat transfer rate from the pressure roller.
